(19) United States
(12) Patent Application Publication
(10) Pub. No.: US 2010/0102561 A1
(43) Pub. Date: Apr. 29, 2010

(54) Using sail and wind power to generate electricity, and as a power source

(76) Inventor: Sami A. Zoda, Paterson, NJ (US)

Correspondence Address: Sami A. Zoda, 364 Sussex Street, Paterson, NJ, 07503, US

(21) Appl. No.: 12/383,800

(22) Filed: Mar. 30, 2009

Related U.S. Application Data
(60) Provisional application No. 61/123,995, filed on Apr. 14, 2008.

(30) Foreign Application Priority Data
Jan. 22, 2009 (GB) 0810767.4

(51) Int. Cl. F03D 9/00; F03D 9/02

(52) U.S. Cl. 290/50; 290/55

(57) ABSTRACT

Specially designed masts, rectangular sails that slide inside frames and can be folded or wrapped, and directing the wind around the system by using a wind deflector and a fin, are used to produce power from the wind, masts will rotate around an oval wall in a circle and drive chains that will turn wheels that in turn drive generators, fin and wind deflector are used to position the system, all parts of the system are installed on one rotating platform, the system is mobile, simple design, made of low cost material, can look like a beautiful sail ship and environmentally friendly, so less people will object to it, multiple small generators that can go on or off-line automatically, are preferred over one large generator, to control the production and speed of the system, generators can physically be added or taken out of the system without halting it.

### BACKGROUND OF THE INVENTION

This invention is for renewable energy power generation, it is suited mostly for generating electricity, but the rotating power produced can be used for other applications. It uses the power in the wind to generate energy without producing environmentally harmful materials. This invention is the result of long study and research and some simple experiments to find solutions for using the power of the sail repeatedly in a small space on hard surface and water.

### BRIEF SUMMARY OF THE INVENTION

Sails are used for a very long time, but they are used for long distance in one direction. This invention uses the same technology, but it solves the problem of returning the sail back to its original drive position and repeats the cycle to produce more power, within a small space. The special mast and sail design, the use of sail wrapping and folding is not used in repeated cycles in any application, I used this technology to build a system that runs continuously and produce power without polluting the environment.

### How the System Works:

The system uses the energy in the wind to produce mechanical power that can be used to generate electricity. When set on a site, it will not move from its position, but the masts & sails 7 & 8, and the chains 9 will move on a platform 2, in a circle around an oval wall 3. Specially designed masts and sails, manipulation of the sails, positioning of the system, and directing the wind movement around the system, all makes it possible for the system to run and produce power. Fin 11 and wind deflector 26 are used to position the system for maximum output.

### BRIEF DESCRIPTION OF THE DRAWINGS

Five drawings are supplied.

FIG. 1: is a top view of the system. Only part of the complete circular base 1 is showing, to keep sufficient space on paper for other parts. No 2 is a rectangular platform that sits in the middle of the circular base, it can rotate 360 degrees, all parts of the system are located on this platform. No 3 is an oval wall in the middle of the platform to support the masts, tracks, chains, and generators. No 11 is a fin, located in the middle of the oval wall, for system positioning and wind redirection. No 7 is a mast that is supported by the tracks and rotate around the oval wall to drive the chains, it is driven by an open sail. No 8 is same as No 7, but the sail will be wrapped or folded in this side. No 9 are the chains that connect to the masts and travel with them, these chains will turn wheels that will turn generators 10 at higher speed, generators can be located at any position close to the chains. No 26 is a wind deflector, which consist if a thin curved wall to direct the wind away from masts No 8 and to position the system relative to the wind direction. Positions X, Y, and Z are locations on the platform used to clarify the operation and state of some parts in these locations, sails will open and close, frame 22 and plate 23 will change orientation at these locations.

FIG. 2: is a side view of the system, uses the same parts and numbering that are in FIG. 1, it also shows the wheels for the base and between the base and platform

FIG. 3: showing 3 ways of folding or wrapping the sails. Pulleys 16, weights 15, and motors 14 are used to perform these operations. FIG. 3A has a bottom bar 20 that can be lifted up, or used as a slide for wrapping the sail when it is moving against the wind. FIGS. 3B and 3C use a rectangular frames 22 for the sail to slide inside them for opening and closing.

FIG. 4: is a showing the rectangular frame 22, and the shape of the mast 4 when the sail is open and when closed. FIG. 4A is a front view showing the inside of the masts V, with the wrapping pipe 25 inside it, in this position the sail is open.

FIG. 4B is a top view of the mast, frame, and sail that is wrapped around the pipe 25. In this figure the sail is closed and the mast moving against the wind.

FIG. 5: mainly showing the position of the movable plate 23 that is located behind the frame 22, in various positions on the platform 2. This design is employed when sail wrapping or folding is not used, instead the frame and sail are rotated about 90 degrees to align them in parallel with the wind, and minimize the effect of the wind on the returning mast and sail. Mast will return to its open drive position at position X with the help of the plate 23. 24 is an exploded view of the mast 4, frame 22, and wrapping pipe 25, when the sail is open and in drive position.

The following list is for the parts of the system, as shown on the drawings.

| | | | |
|---|---|---|---|
| 1 | Circular base in wheels. 12. | 2 | Rectangular rotating |
| | | | platform. |
| 3 | Oval wall | 4 | Mast |
| 5 | Mast + Frame + Pipe for wrapping | 6 | Tracks |
| 7 | Mast with open sail | 8 | Mast with closed sail |
| 9 | Chain | 10 | Generator (G) |
| 11 | Fin | 12 | Wheels for the base |
| 13 | Bearings between base and platform | 14 | Motor |
| 15 | Weight | 16 | Pulley |
| 17 | Rotating pipe inside the mast | 18 | Segmented folding sail |
| 19 | One piece sail | 20 | Sail bottom bar |
| 21 | Wrapped sail | 22 | Frame for sail |
| 23 | Movable plate | 24 | Cross section of mast |
| | | | assembly |
| 25 | Rope | 26 | Wind deflector |

### DETAILED DESCRIPTION

The followings are descriptions for the system parts and how they are used.

### Base:

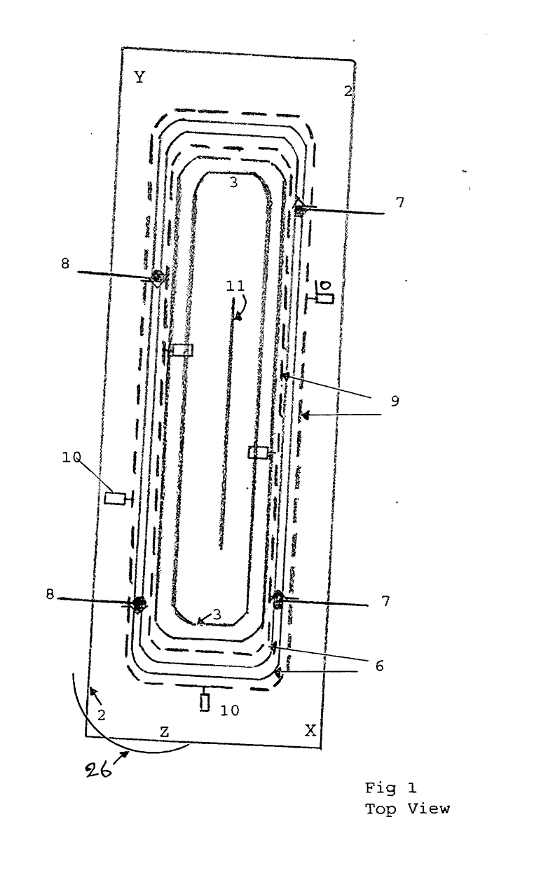

The round base 1 is mounted on wheels 12, so the system can be moved easily to the site or relocated. The platform 2 sits in the middle of this base. FIGS. 1 & 2

### Platform:

The rectangular platform 2 sits in the middle of the base 1 and can turn about 360 degrees to position the system for maximum possible efficiency in response to changing wind direction. All parts of the system are installed on this platform. The platform may be positioned in a small angle relative to the wind direction; the reason for this is to direct the wind to drive the sail 7 when it is open, and to reduce the effect of the wind on the mast 8 that is moving against the wind on the other side of the oval wall. Tracks 6 for supporting the rotating masts in upright position, and chains 9 can be installed on the platform floor and oval wall. FIGS. 1 & 2

### Oval Wall:

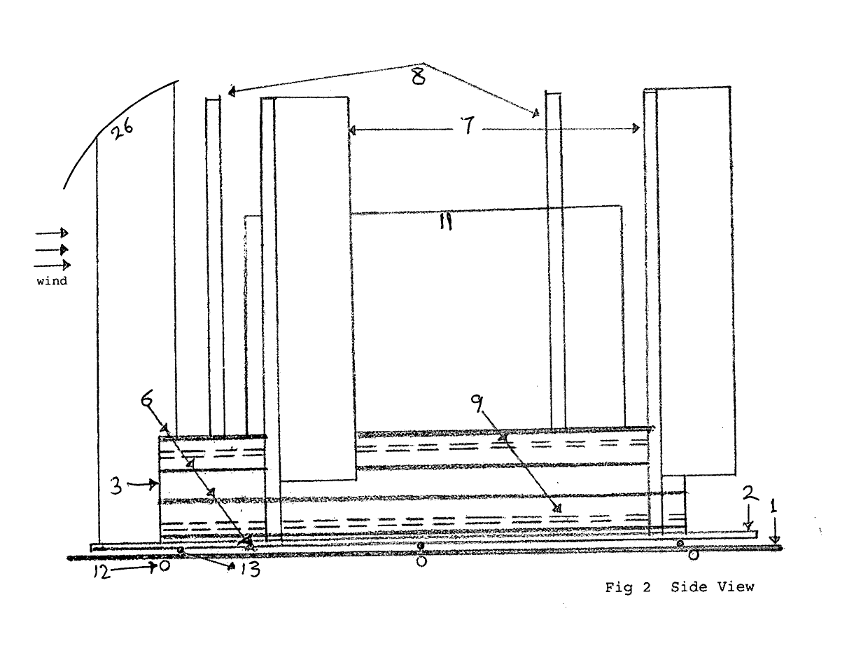

In the middle of the platform, an oval shaped wall 3 is built to support the masts in upright position by using multiple tracks 6. It can also be used to install chains 9 and generators 10 close to the chains. Generators can be installed inside specially built compartments in the wall itself or supported by the wall and platform, special snap-on levers are used to install or remove the generators as required while the system is running. The middle part of the wall will have space to house batteries, spare parts, tools, and other related items. In the middle and above the oval wall a thin wall 11 will be built, to be used as a fin for positioning the system, and to reduce the wind pressure on the mast that is moving against the wind on the other side. FIGS. 1, 2 & 5

### Mast:

Mast 4 will have a V shaped channel, on one side; the inside of the V will face the wind when the sail is open 7, and help produce more power. When a mast reaches the end of the platform Y and rotates to travel against the wind, the back part of the V will face the wind 8, this will reduce the resistance to move against the wind. The channel has other purpose; it has a pipe 25 installed inside it, this pipe is connected to a motor 14 and the sail, the sail will wrap around this pipe and conceal inside the mast's V. The sail frame 22 is connected to the mast and move with it. Three or more masts will rotate around the oval wall driven by the sails. To start the system, at least one sail should be open and in drive position facing the wind. FIGS. 1, 2, 3, & 4

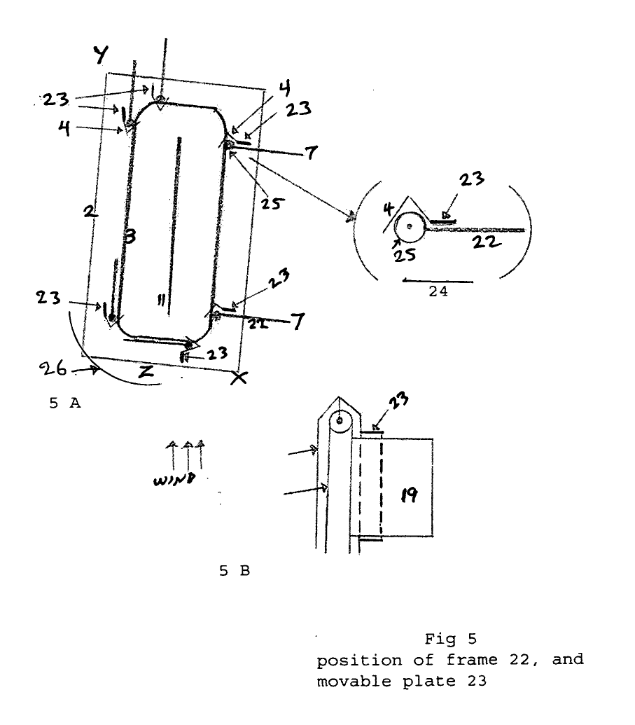

In FIG. 5 the returning sails will not use folding or wrapping, but they will move against the wind by using frame rotation and wind redirection. The fin 11 and the wind deflector 26 will direct the wind away from the returning sail, motor will not be needed for this version. The sail frame 22 is not connected to the mast as above, but it is connected to the pipe inside the mast, this pipe can turn about 90 degrees at points X & Y by the wind force. At point Y, the frame turns about 90 degrees clockwise and align the sail in parallel with the wind. A rectangular movable plate 23 will be connected to the mast behind the frame, it can turn freely about 80 degrees, this plate will act like a small sail and help the frame turn counter-clockwise at point X, and return the frame and sail to open drive position.

FIG. 5A shows the position of the frame 22 and plate 23 in all 4 four sides of the platform. At point X, and when the mast start to turn, the plate will get exposed to the wind force first, it will act as a small sail to help the mast turn around the wall, then the wind force will turn the frame about 90 degrees counter-clockwise to open position. FIGS. 1 & 5A

### Sail:

Is the part that will drive the masts, chains, and wheels, similar to a bicycle chain and wheel. The wheels will drive generators to produce electricity, or used as a power source for other purposes. Rectangular sail that can be a thin piece of sheet metal or special material, will slide inside a rectangular frame that is connected to the mast.

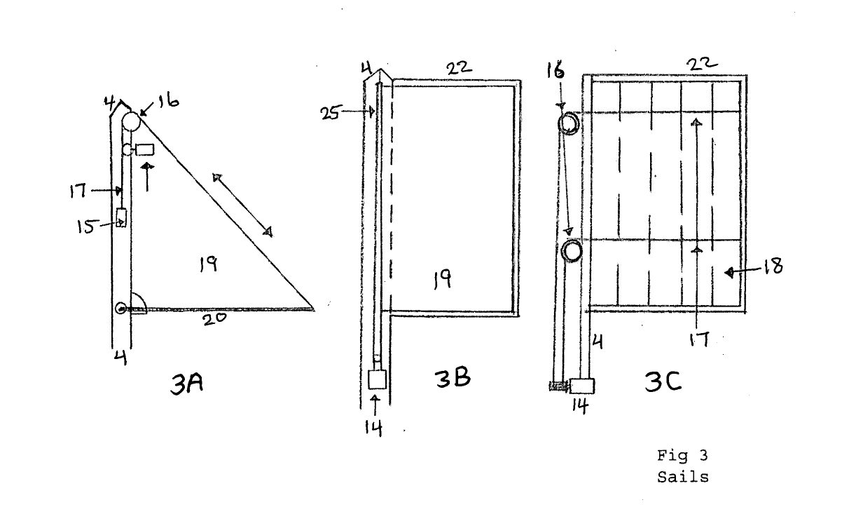

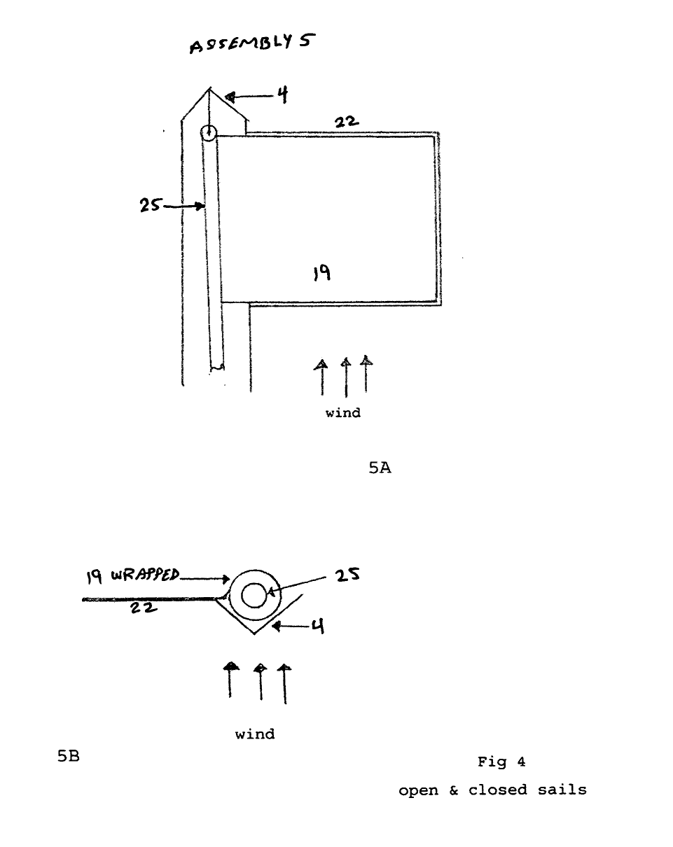

Sail will be in open position when it is moving in the direction of the wind, and will fold (FIG. 3C) or wrap around a pipe (FIG. 3B) at the end of the platform Y and conceal inside the mast's V channel, as described in MAST section, then travel with minimum resistance against the wind. Since the returning mast is moving on the other side of the oval wall and fin, and the effect of the V shape, it will be exposed to less wind. Also the wind deflector 26 will direct the wind away from the mast and sail frame. FIGS. 1, 2, 3, & 4

The following are 3 ways for folding or wrapping a sail.

a—If the sail has a horizontal bar on the bottom, this bar will be lifted toward the mast. FIG. 3A. Or if a metal track is used as a bottom bar, then the bottom part of the sail slides inside this track similar to FIG. 3B; this will require the use of a pipe and a motor to wrap the sail.
b—Sail can be connected to a vertical rotating pipe, that is installed inside the mast's V. The sail wraps around it at Y, then open again at the beginning of the platform X. FIG. 3B
c—Sail can be build like a folding door, and folded horizontally toward the mast at Y, and open again at position X. FIG. 3C.

In FIGS. 3B & 3C, sails will slide inside rectangular frames and open or closed as needed. Sail folding or wrapping is controlled by electric DC motors, connected to

manual override switches, all sails will be folded in case of a very high wind, and the system locked to prevent damage. Power to DC motors that control the operation of the sails, lighting, electronic controls, and other needs will be supplied by a dedicated battery that will be charged and used by the system.

### Chain:

Chains will be driven by the masts and move with them around the oval wall, the chain will turn wheels that in turn drive the generators at higher speed. Chains can be installed at any place that makes it easy to connect to the mast and install wheels and generators.

### Generator:

Multiple small generators 10 are preferred over one large generator. The system can be started easily with one or no generator on line and add generators automatically as the speed increases. Generators will be installed in special compartments with one lever movement for easy insertion and removal while the system is running. Adding more generators online automatically is used also to reduce the speed of the system in case of high wind.

Some important features of this system is that it is simple, made of inexpensive materials, mobile and can be moved easily if the space is needed in the future, unlike the wind turbine that will require cranes and lots of effort to disassemble. Needs small space, can be installed on flat roofs, fields, or offshore, if installed on boats and ships, can be used as normal sail when moving by locking all the sails in open position, and used to produce electricity when the boat is not moving.

What is claimed is:

1. An invention for a power generating system that uses renewable energy, by utilizing the power in the wind, the system uses multiple sails and generators to produce electricity, specially designed masts, sails that move inside frames, frame rotation, and wind redirection, will allow the sails and masts to rotate around an oval shaped wall and drive chains, the chains will turn wheels that will drive generators, fin and wind deflectors are used to direct the wind and position the system for highest efficiency, tracks that support the masts, generators, and the chains that drive wheels can be installed on or supported by the oval wall and the platform, the system is mounted on wheels for easy moving and relocation.

2. A power generating system according to claim 1, uses masts that are shaped like V, the inside of the V will face the wind when the sail is open, the back of the V will face the wind when the sail is folded or wrapped and the mast is moving against the wind, inside the mast's V is a pipe that connects to the sail and a motor, the sail will wrap around this pipe and will conceal inside the V, this will greatly reduce the wind effect on the returning mast.

3. A power generating system according to claims 1 & 2, the returning mast and sail can be moved against the wind without folding, by allowing the sail and frame to rotate about 90 degrees and align itself in parallel with the wind, air deflector, a rotating plate, and the fin will reduce the effect of the wind on the returning sail, for this design, a rotating rectangular plate is added to the mast on one side to help the frame and sail to turn to original drive position at the start of the platform.

4. A power generating system according to claims 1, 2 & 3, specially built rectangular sail, moving inside a rectangular frame, can be folded toward the mast, or wrapped around a pipe inside the mast's V to reduce the effect of the wind on the returning mast, bidirectional DC motors are used to open and close the sails.

5. A power generating system according to claims 1, 2 & 3, mast that move around the oval wall, will drive chains that will turn wheels, these wheels will turn generators at higher speed to produce electricity or used to drive machines.

6. A power generating system according to claims 1 & 5, multiple small generators are installed inside special compartments will engage the turning wheels and turn at higher speed to produce electricity, generators come on-line automatically as the system speed increase, and go off-line when the system speed decrease, this will help to control the speed of the system when the winds are strong.

7. Power needed to operate motors, lighting and controls is supplied by the system itself, by charging dedicated batteries located in the centre and inside the oval wall, manual override switches are provided to control the opening or closing of the sails as needed and especially to wrap all the sails and stop the system in very high wind.

8. A power generating system according to any of the proceeding claims, all parts of the system are installed on one rotating platform that rotate on a circular base for positioning, the base is fitted with wheels for easy moving or relocation, a fin and a wind deflector are used to position the system relative to the wind direction, an oval shaped wall is built in the middle of the platform to support the tracks that will keep the masts in upright position and support the chains and generators.
